(19) United States
(12) Patent Application Publication
(10) Pub. No.: US 2017/0064189 A1
(43) Pub. Date: Mar. 2, 2017

(54) IMAGING APPARATUS, FOCUS POSITION DETECTION APPARATUS, AND FOCUS POSITION DETECTION METHOD

(71) Applicant: FUJITSU LIMITED, Kawasaki-shi (JP)

(72) Inventors: Megumi CHIKANO, Kawasaki (JP); Shohei NAKAGATA, Kawasaki (JP); RYUTA TANAKA, Machida (JP)

(73) Assignee: FUJITSU LIMITED, Kawasaki-shi (JP)

(21) Appl. No.: 15/242,705

(22) Filed: Aug. 22, 2016

(30) Foreign Application Priority Data
Sep. 1, 2015 (JP) 2015-172038

(51) Int. Cl. H04N 5/232; H04N 5/225

(52) U.S. Cl. CPC H04N 5/23212; H04N 5/2253

(57) ABSTRACT

A focus position detection apparatus calculates, for each shift amount calculation area in a measurement area set on an image sensor of a camera, a local shift amount between a first sub-image generated by first pixels and a second sub-image generated by second pixels, and a degree of reliability of the local shift amount, and corrects the degree of reliability base on a level of inclusion of components included in a subject image in the shift amount calculation area and being finer than a distance between two adjacent first pixels or a distance between two adjacent second pixels. The focus position detection apparatus then calculates a representative value representing a distance between a focus position by an optical system of the camera and the image sensor so that influence of the local shift amount of each shift amount calculation area increases as the corrected degree of reliability increases.

### CROSS-REFERENCE TO RELATED APPLICATION

This application is based upon and claims the benefit of priority of the prior Japanese Patent Application No. 2015-172038, filed on Sep. 1, 2015, and the entire contents of which are incorporated herein by reference.

### FIELD

The embodiments discussed herein are related to a focus position detection apparatus and a focus position detection method which detect a focus position for a subject on the basis of an image captured by imaging the subject, and an imaging apparatus which uses the focus position detection apparatus.

### BACKGROUND

Apparatuses which image a subject, such as digital cameras and video cameras, have incorporated a technique which automatically measures a distance to a subject and focuses on the subject on the basis of a result of the measurement (so-called autofocus) in order to generate a sharp image of the subject.

Among such autofocus (AF) methods, a phase difference detection method is known as an example of a method which uses a light beam passing through an imaging optical system. In the phase difference detection method, a light beam coming from a subject and passing through the imaging optical system is split into two, and a displacement of an image sensor from a focus position is determined from a distance between locations of images of the subject produced by the respective two light beams on the image sensor. A focal point position of the imaging optical system is then adjusted so that the locations of the images of the subject produced by the respective two light beams coincide with each other. In the phase difference detection method, for example, an area where a focus position can be detected by the phase difference detection method is set on the image sensor. For each of a plurality of solid-state imaging elements included in the area and arranged in one row, half of a light receiving surface of the solid-state imaging element located on an image surface side of a microlens for condensing light, being perpendicular to a direction in which the solid-state imaging elements are arranged, is masked, thereby obtaining an image of the subject which corresponds to one of the light beams. Similarly, for each of a plurality of solid-state imaging elements included in the area and arranged in the other row, the other half of the light receiving surface of the solid-state imaging element located on the image surface side of the microlens for condensing light, being perpendicular to a direction in which the solid-state imaging elements are arranged, is masked, thereby obtaining an image of the subject which corresponds to the other of the light beams.

A technique is proposed which provides a plurality of such areas on an image sensor to enable AF by using a phase difference detection method in a plurality of locations in the image sensor (for example, see Japanese Laid-open Patent Publication No. 2007-52072). In the technique disclosed in Japanese Laid-open Patent Publication No. 2007-52072, a specific focal-point-detection field-of-view to be used for focal point adjustment is selected for each focal-point-detection field-of-view, on the basis of an evaluation value including at least three of coincidentally paired object images, the number of edges of the object images, degrees of sharpness of the object images, and light-dark ratios of the object images, as parameters.

### SUMMARY

In some cases, pixels each having a light receiving surface which is partially masked (hereinafter referred to as a phase difference pixel for convenience) to be used for generating images for phase difference detection are discretely arranged in an area in which a focal point can be detected by a phase difference detection method (hereinafter referred to as an AF area for convenience). Such an arrangement is made to prevent deterioration of image quality of the AF area in an image for display. In this case, the edge becomes shaper so that an edge width of an image of the subject is narrower than a distance between two adjacent phase difference pixels, it becomes difficult to accurately evaluate the edge of the image of the subject in an image for phase difference detection. This makes it difficult to accurately evaluate reliability of the result of the focal point detection in the AF area, consequently reducing accuracy in focal point detection, in some cases.

According to one embodiment, an imaging apparatus is provided. The imaging apparatus includes: a camera which includes an image sensor in which phase difference detectors detecting a phase difference to be used for calculating a focus position by using an image surface phase difference detection method, are disposed at a plurality of locations in a light receiving surface, and captures an image of a subject by using a light incident on the light receiving surface of the image sensor via an optical system with a movable focal point position; and a processor configured to calculate, when a frequency value calculated by using a pixel value located between a first phase difference detector and a second phase difference detector among a plurality of the phase difference detectors is larger than or equal to a predetermined value, the focus position based on phase differences detected by a plurality of the phase difference detectors with reduced contribution of a phase difference by the first phase difference detector and the second phase difference detector.

According to another embodiment, a focus position detection apparatus is provided.

The object and advantages of the invention will be realized and attained by means of the elements and combinations particularly detailed in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic block diagram of a digital camera, which is an example of an imaging apparatus incorporating a focus position detection apparatus.

FIG. 2 is a diagram illustrating an example of an AF area provided on an image sensor.

FIG. 3 is a diagram illustrating examples of sub-images generated respectively by two pixel rows in the AF area illustrated in FIG. 2.

FIG. 4 is a functional block diagram of a control unit.

FIG. 5 is a diagram illustrating an example of a relationship between a measurement area and shift amount calculation areas.

FIG. 6A is a diagram illustrating a principle of equiangular linear fitting.

FIG. 6B is a diagram illustrating the principle of equiangular linear fitting.

FIG. 7A is a diagram illustrating an example of arrangement of phase difference pixels.

FIG. 7B is a diagram illustrating an example of a relationship between a phase difference pixel distance and edges in a left-hand image and a right-hand image.

FIG. 7C is a diagram illustrating an example of a relationship between a phase difference pixel distance and edges in a left-hand image and a right-hand image.

FIG. 8 is an explanatory diagram of inclusion level calculation.

FIG. 9 is an operation flowchart of a process for detecting a focus position.

FIG. 10 is an explanatory diagram of inclusion level calculation according to a second embodiment.

FIG. 11A is a diagram illustrating a relationship between an image sensor for generating phase difference images and an image sensor for generating display images, according to a modified example.

FIG. 11B is a diagram illustrating a relationship between image sensors for generating phase difference images and an image sensor for generating display images, according to the modified example.

### DESCRIPTION OF EMBODIMENTS

A focus position detection apparatus will be described with reference to the drawings. The focus position detection apparatus obtains a focus position in an entire measurement area by calculating a shift amount between two images of a subject in each of a plurality of AF areas included in the measurement area on an image sensor, and a degree of reliability of the shift amount, and obtaining a weighted mean of the shift amounts using the degrees of reliability. In this regard, the focus position detection apparatus evaluates, for each AF area, a level of inclusion of components which are included in the image of the subject and are finer than a distance between two phase difference pixels adjacent to each other in a direction for which the shift amount is obtained. The focus position detection apparatus reduces the degree of reliability of the AF area as the level of inclusion increases.

For convenience of explanation, each phase difference pixel to be used for generating one image of a subject for phase difference detection in an AF area will be referred to as a left pixel, and each phase difference pixel to be used for generating the other image of the subject in the AF area will be referred to as a right pixel, below. A sub-image of the subject generated by a set of right pixels in the AF area will be referred to as a right-hand image, and a sub-image of the subject generated by a set of left pixels in the AF area will be referred to as a left-hand image. In some cases, the right-hand image and the left-hand image will be referred to collectively as phase difference images. The distance between two phase difference pixels adjacent to each other in the direction for which a shift amount is obtained will be referred to simply as a phase difference pixel distance.

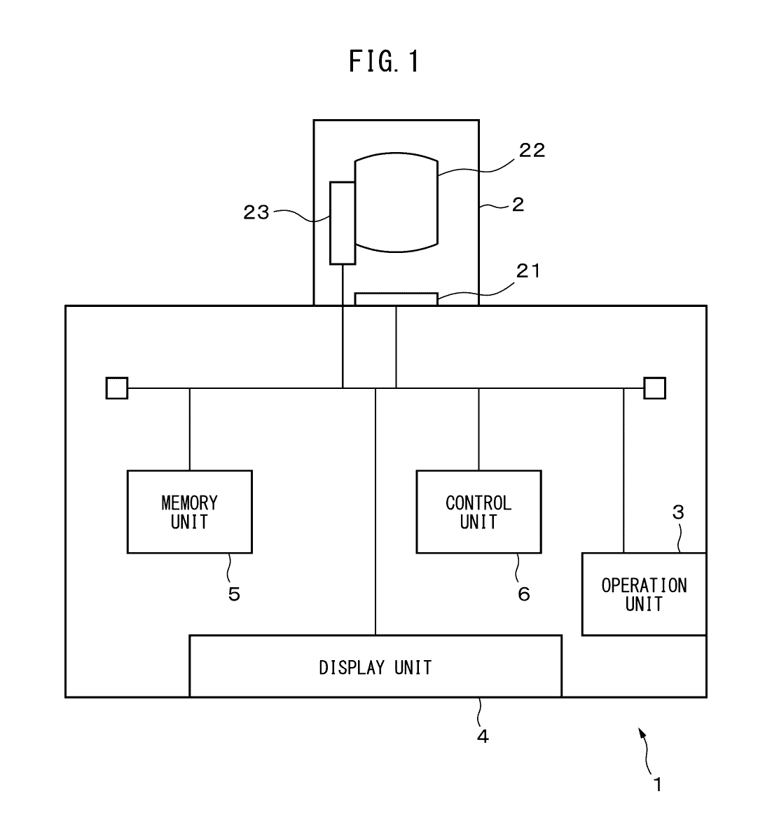

FIG. 1 is a schematic block diagram illustrating a digital camera, which is an example of an imaging apparatus incorporating a focus position detection apparatus. As illustrated in FIG. 1, the digital camera 1 includes an imaging unit 2, an operation unit 3, a display unit 4, a memory unit 5, and a control unit 6. The digital camera 1 may further include an interface circuit (not depicted) conforming to a serial bus standard such as Universal Serial Bus for connecting the digital camera 1 to a computer or other apparatuses such as a television set. The control unit 6 is connected to the other units of the digital camera 1 through a bus, for example. Note that the focus position detection apparatus is applicable to various apparatuses which include an imaging unit.

The imaging unit 2 includes an image sensor 21, an imaging optical system 22, and an actuator 23. The image sensor 21 includes an array of solid-state imaging elements arranged in a two-dimensional array and generates an image. A microlens, for example, for condensing light is provided on the front of each of the solid-state imaging elements. A plurality of AF areas are provided in the image sensor 21. The imaging optical system 22 is provided in front of the image sensor 21, includes one or more lenses arranged along the optical axis, for example, and forms an image of a subject on the image sensor 21 in focus. The actuator 23 includes a stepping motor, for example, and causes the stepping motor to rotate by an amount of rotation in accordance with a control signal from the control unit 6 to move some or all of the lenses of the imaging optical system 22 along the optical axis, thereby adjusting a focus position. Each time generating an image in which a subject is captured, the imaging unit 2 sends the generated image to the control unit 6.

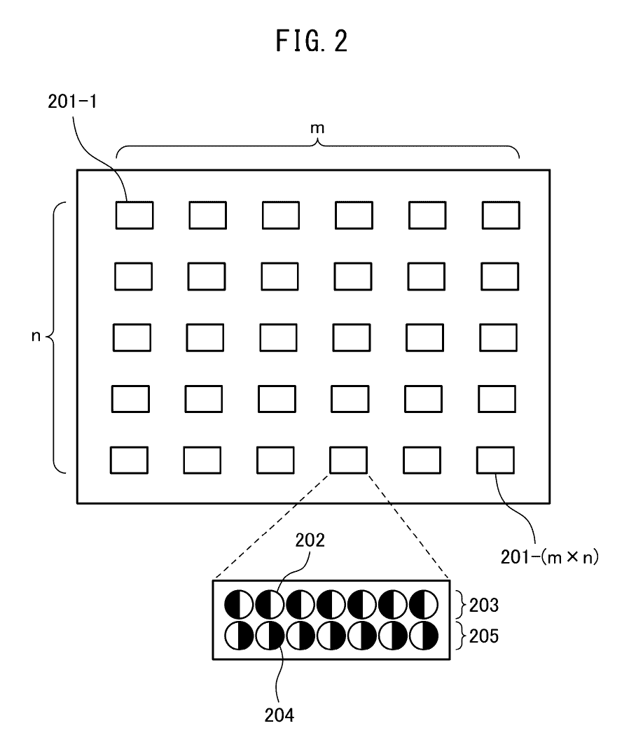

FIG. 2 is a diagram illustrating an example of AF areas provided on the image sensor 21. In this example, m in the horizontal direction and n in the vertical direction of AF areas 201-1 to 201-(m×n) are provided in an imaging region 200 in which the image sensor 21 generates an image (where m≧1, n≧1). Each AF area generates a left-hand image generated by a left-pixel row 203 in which a plurality of left pixels 202 are arranged in the horizontal direction and a right-hand image generated by a right-pixel row 205 in which a plurality of right pixels 204 are arranged in the horizontal direction. Each solid-state imaging element corresponding to a left pixel has a light receiving surface a left half of which is masked, for example. Each solid-state imaging element corresponding to a right pixel has a light receiving surface a right half of which is masked, for example.

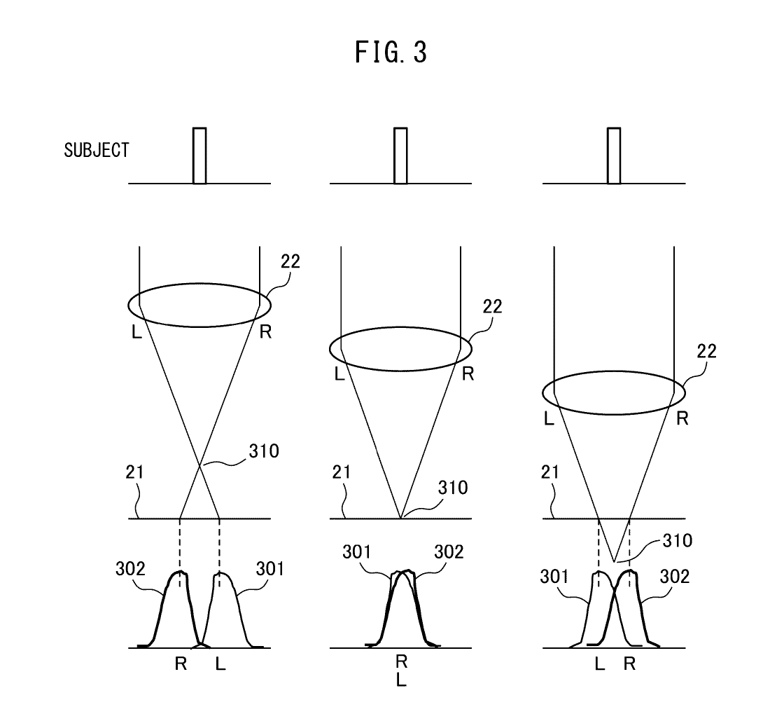

FIG. 3 is a diagram illustrating examples of a left-hand image and a right-hand image generated respectively by the two pixel rows in the AF area illustrated in FIG. 2. A left-hand image 301 generated by the left-pixel row 203 and a right-hand image 302 generated by the right-pixel row 205 are substantially coincident with each other when a focus position 310 produced by the imaging optical system 22 for a subject appearing in the AF area is on the image sensor 21. However, when the focus position 310 produced by the imaging optical system 22 is closer to the subject than the image sensor 21, i.e., when the focus position 310 is in front of the image sensor 21, the left-hand image 301 shifts to the right from a location where the left-hand image 301 appears when the subject is in focus. On the other hand, the right-hand image 302 shifts to the left from a location where the right-hand image 302 appears when the subject is in focus. Conversely, when the focus position 310 produced by the imaging optical system 22 is farther away from the subject than the image sensor 21, i.e., when the focus position 310 is behind the image sensor 21, the left-hand image 301 shifts to the left from a location where the left-hand image 301 appears when the subject is in focus. On the other hand, the right-hand image 302 shifts to the right from a location where the right-hand image 302 appears when the subject is in focus. Therefore, when a degree of coincidence between the left-hand image 301 and the right-hand image 302 is measured while one of the left-hand image 301 and the right-hand image 302 is shifted in the horizontal direction with respect to the other, the shift amount when the left-hand image 301 and the right-hand image 302 are most coincident with each other, represents an amount of displacement of the image sensor 21 from the focus position. Accordingly, by moving the imaging optical system 22 so that the shift amount reaches 0, the control unit 6 can cause the imaging unit 2 to focus on the subject.

The operation unit 3 includes, for example, various operation buttons or a dial switch used by a user to operate the digital camera 1. The operation unit 3 sends a control signal for starting imaging or focusing or a setting signal for setting a shutter speed or aperture, to the control unit 6 in response to a user operation.

The operation unit 3 also sends information representing an area in which the focus position of the imaging unit 2 in an imaging region is detected (hereinafter referred to as a measurement area for convenience) to the control unit 6 in response to a user operation. A plurality of measurement areas, such as the center, upper left, lower right of an imaging region and the entire imaging region, are preset and a user selects one of the measurement areas by operating on the operation unit 3. Alternatively, a measurement area may be set in an arbitrary location within an imaging region.

The display unit 4 includes, for example, a display apparatus such as a liquid-crystal display, and displays various kinds of information received from the control unit 6 or images generated by the imaging unit 2. Note that the operation unit 3 and the display unit 4 may be integrated into one unit using a touch panel display, for example.

The memory unit 5 includes, for example, a readable and writable, volatile or nonvolatile semiconductor memory circuit. The memory unit 5 stores images received from the imaging unit 2. The memory unit 5 also stores various kinds of data used by the control unit 6 for detecting a focus position. The memory unit 5 stores data such as, for example, information representing a location and a range of each AF area (for example, coordinates of the upper left corner and the lower right corner of each AF area on an image generated by the imaging unit 2), identification information of each AF area, and the like. In addition, the memory unit 5 stores a focal point position table used for adjustment of a focal point position of the imaging optical system 22. The focal point position table indicates a relationship between a shift amount corresponding to a distance from the imaging unit 2 to a subject when the imaging optical system 22 is at a reference position and an amount of rotation of the stepping motor, which corresponds to an amount of movement of the imaging optical system 22 for causing the imaging optical system 22 to focus on the subject at the distance. For example, the reference position of the imaging optical system 22 corresponds to a position of the imaging optical system 22 when the imaging optical system 22 focuses on infinity. When the respective functions included by the control unit 6 are implemented by a computer program executed on a processor included by the control unit 6, the memory unit 5 may store the computer program.

The control unit 6 is an example of a focus position detection apparatus and includes at least one processor and a peripheral circuit thereof. The control unit 6 controls the entire digital camera 1. Further, the control unit 6 detects a focus position on the basis of an image received from the imaging unit 2 and adjusts the focus position of the imaging optical system 22 on the basis of the detected focus position.

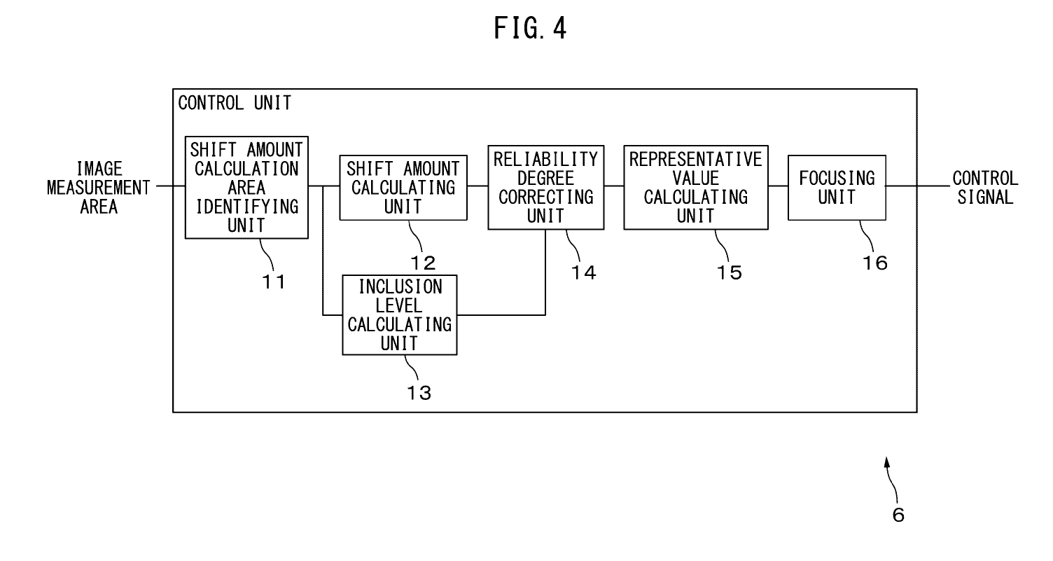

FIG. 4 is a functional block diagram of the control unit 6, related to focus position detection and focus position adjustment. The control unit 6 includes a shift amount calculation area identifying unit 11, a shift amount calculating unit 12, an inclusion level calculating unit 13, a reliability degree correcting unit 14, a representative value calculating unit 15, and a focusing unit 16. These units included by the control unit 6 are implemented, for example, as function modules realized by a computer program executed on the processor of the control unit 6. Alternatively, one or more integrated circuits which realize the functions of the respective units included by the control unit 6 may be incorporated in the digital camera 1 separately from the control unit 6.

The shift amount calculation area identifying unit 11 identifies an AF area included in a measurement area selected or set by a user on the image sensor 21 as a shift amount calculation area. In this regard, the shift amount calculation area identifying unit 11 retrieves information indicating locations and ranges of the respective AF areas from the memory unit 5. The shift amount calculation area identifying unit 11 may then refer to the information indicating the locations and ranges of the respective AF areas to identify an AF area which at least partially overlaps a measurement area as a shift amount calculation area. Alternatively, the shift amount calculation area identifying unit 11 may identify an AF area which is completely included in a measurement area as a shift amount calculation area.

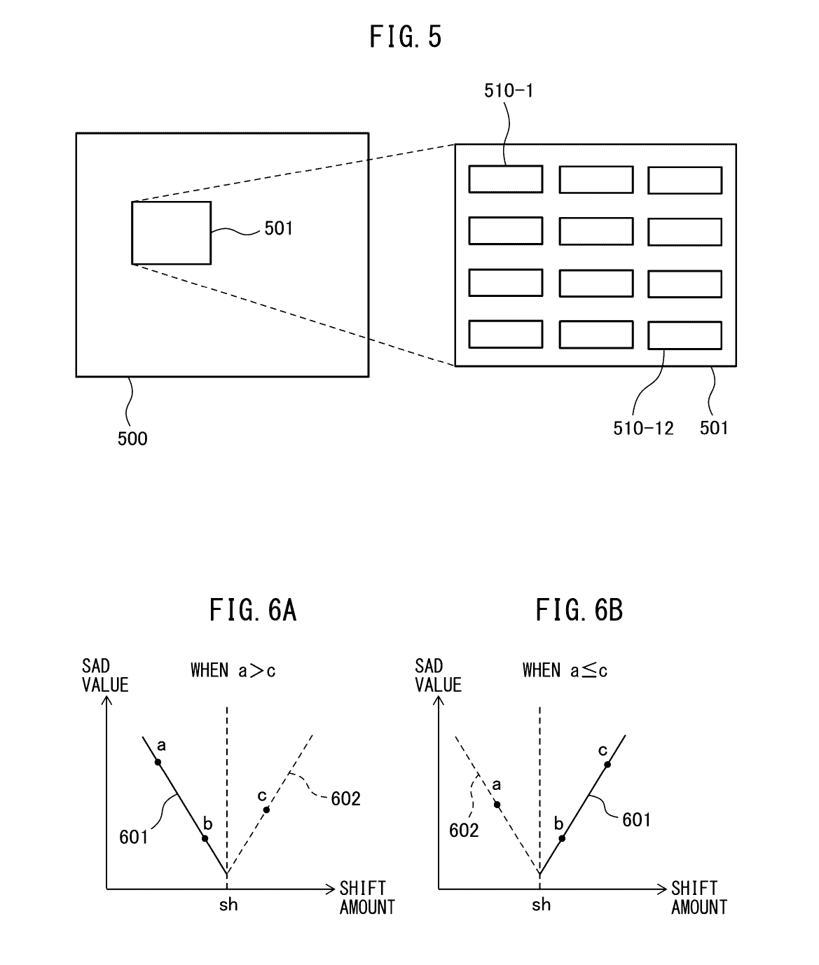

FIG. 5 is a diagram illustrating an example of a relationship between a measurement area and a shift amount calculation area. In this example, twelve AF areas, 502-1 to 502-12, are included in a measurement area 501 set in an imaging region 500 in which an image is generated by the image sensor 21. Accordingly, each of the AF areas 502-1 to 502-12 are identified as a shift amount calculation area.

The shift amount calculation area identifying unit 11 provides identification information of each AF area identified as a shift amount calculation area for the shift amount calculating unit 12.

The shift amount calculating unit 12 calculates, for each shift amount calculation area identified by using identification information of an AF area provided by the shift amount calculation area identifying unit 11, a shift amount when a left-hand image and a right-hand image are most coincident with each other, and a degree of reliability representing accuracy of the shift amount.

Calculation of a shift amount in each shift amount calculation area when a left-hand image and a right-hand image are most coincident with each other (hereinafter referred to as a local shift amount for convenience) will be described first.

The shift amount calculating unit 12 calculates, for example, a sum of absolute differences (SAD) between pixel values of corresponding pixels while shifting a location of a right-hand image with respect to a left-hand image pixel by pixel. Then, the shift amount calculating unit 12 can define the shift amount of the right-hand image with respect to the left-hand image when the SAD value is minimal, as a local shift amount.

The shift amount calculating unit 12 can calculate SAD(s) for a shift amount s for each shift amount calculation area in accordance with an equation given below, for example.

$$SAD [ s ] = {{\sum }^{N - 1}}_{n = 0} \vert R [ n + s + S ] - L [ n + S ] \vert \\ ( - S ≦ s ≦ S ) \qquad ( 1 )$$

where N represents the number of pixels in a left-hand image and a right-hand image used for one SAD calculation. +S to −S represents a range of shift amounts from which a local shift amount is to be found. L[n] and R[n] represent values of n-th pixels in the left-hand image and the right-hand image, respectively.

In equation (1), a local shift amount is calculated on a pixel-by-pixel basis. In reality, however, the local shift amount at which the SAD value is minimal is not necessarily in pixels. The shift amount calculating unit 12 therefore obtains a local shift amount on a subpixel-by-subpixel basis by equiangular linear fitting using a shift amount at which the SAD value is minimal in accordance with equation (1) and SAD values for shift amounts around the shift amount.

FIGS. 6A and 6B are diagrams illustrating a principle of the equiangular linear fitting. In FIGS. 6A and 6B, the horizontal axis represents shift amounts and the vertical axis represents SAD values. b represents the minimum value of SAD calculated in accordance with equation (1), a represents a SAD value when the shift amount is smaller than the shift amount corresponding to the minimum SAD value by one pixel, and c represents a SAD value when the shift amount is greater than the shift amount corresponding to the minimum SAD value by one pixel. In the equiangular linear fitting, it is assumed that a gradient of increase of the SAD value when the shift amount is decreasing from a local shift amount is equal to a gradient of increase of the SAD value when the shift amount is increasing.

Therefore, a line 601 which passes through a point corresponding to the minimum SAD value b and a point corresponding to an adjacent point a or c, either of which corresponds to a greater SAD value, i.e., the line ab or the line bc, either of which has a greater absolute value of gradient, is obtained. When a>c as illustrated in FIG. 6A, the line 601 is the line ab; on the other hand, when a<c as illustrated in FIG. 6B, the line 601 is the line bc. Additionally, a line 602 which passes through a or c, either of which corresponds to a smaller SAD value, and which has a gradient opposite to the line 601 (i.e., a gradient with the reverse sign), is obtained. A shift amount which corresponds to the intersection between the line 601 and the line 602 is the local shift amount sh on a subpixel-by-subpixel basis.

The shift amount calculating unit 12 can calculate the local shift amount sh using equiangular linear fitting in accordance with the equation given below.

$$sh = \{ \begin{matrix}{s}_{min} + 0.5 \times ( c - a ) / ( b - a ) & ( when a > c ) \\ {s}_{min} + 0.5 \times ( c - a ) / ( b - c ) & ( when a \leq c )\end{matrix} \qquad ( 2 )$$

where sₘᵢₙ represents a shift amount on a pixel-by-pixel basis at which the SAD value is minimal; and a=SAD[sₘᵢₙ−1], b=SAD[sₘᵢₙ] and c=SAD [sₘᵢₙ+1]. The local shift amount sh on a subpixel-by-subpixel basis will hereto be referred to simply as a local shift amount.

When no noise component is included in the respective values of the left pixels included in the left-pixel row, which generates the left-hand image, and the respective values of the right pixels included in the right-pixel row, which generates the right-hand image, the value of the local shift amount calculated as described above is assumed to be relatively accurate. However, when the subject is dark, for example, a degree of contribution of a noise component to values of the respective left pixels and the respective right pixels increases. In such a case, the value of the local shift amount obtained is not necessarily accurate.

Therefore, the shift amount calculating unit 12 calculates a degree of reliability which represents accuracy of the local shift amount for each shift amount calculation area.

In the present embodiment, the shift amount calculating unit 12 calculates an estimation value of variance of a local shift amount, as a degree of reliability. This is because possibility that the value of the local shift amount is accurate generally increases when the variance of the local shift amount is smaller. For convenience, variance of a local shift amount will hereto be referred to as estimated variance.

When the contrast of the subject represented in the left-hand image and in the right-hand image is constant, the minimum SAD value increases as a noise component superimposed on each pixel included in the left-pixel row or the right-pixel row increases, consequently increasing the variance of the local shift amount. On the other hand, when the minimum SAD value is constant, i.e., when a noise component superimposed on each pixel included in the left-pixel row or the right-pixel row is constant, variance of the local shift amount decreases as the contrast of the subject represented in the left-hand image and in the right-hand image increases. In view of these, the shift amount calculating unit 12 calculates an estimation value of variance of the local shift amount on the basis of a ratio of the minimum SAD value to the contrast of the left-hand image or the right-hand image.

The shift amount calculating unit 12 calculates a ratio R of the minimum SAD value to the contrast of the subject represented in the left-hand image or the right-hand image, in accordance with the equation given below.

$$R = \frac{{SAD}_{min}}{C} \qquad ( 3 )$$

where SADₘᵢₙ represents the minimum SAD value among SAD values calculated in accordance with equation (1), and C represents a contrast value. The contrast value C is calculated, for example, as the difference (Pₘₐₓ−Pₘᵢₙ) between a maximum value Pₘₐₓ among pixel values included in the left-hand image and the right-hand image and a minimum value Pₘᵢₙ among pixel values included in the left-hand image and the right-hand image. Alternatively, the contrast value C may be calculated in accordance with (Pₘₐₓ−Pₘᵢₙ)/(Pₘₐₓ+Pₘᵢₙ). Further, Pₘₐₓ and Pₘᵢₙ may respectively be the maximum value and the minimum value of pixel values of one of the left-hand image and the right-hand image.

The shift amount calculating unit 12 can obtain a value of estimated variance corresponding to the ratio R calculated in accordance with equation (3), i.e., a degree of reliability, for example, with reference to a reference table indicating a relationship between the ratio R and the estimated variance. The reference table is created, for example, through an experiment or simulation, by obtaining variation of the local shift amount with respect to the ratio R while changing, to different values, a noise amount superimposed on each pixel value of test patterns of the left-hand image and the right-hand image, each of the test patterns having a known local shift amount and known contrast. The reference table is stored in the memory unit 5 prior to operation.

According to a modified example, the shift amount calculating unit 12 may calculate, as a degree of reliability, an expected value of the absolute value of an error in a local shift amount. In this case, as the above, the shift amount calculating unit 12 may obtain an expected value of the absolute value of an error in a local shift amount corresponding to the ratio R, with reference to a reference table indicating a relationship between the ratio R and an expected value of the absolute value of an error in a local shift amount, the reference table being created and stored in the memory unit 5 prior to operation.

According to another modified example, the shift amount calculating unit 12 may calculate, as a degree of reliability, a probability that a difference between the calculated local shift amount and a correct shift amount, which is the actual shift amount, is equal to or smaller than a predetermined value (e.g., three pixels). In this case, as the above, the shift amount calculating unit 12 may obtain a probability corresponding to the ratio R, with reference to a reference table indicating a relationship between the ratio R and the probability that the difference is equal to or smaller than the predetermined value, the reference table being created and stored in the memory unit 5 prior to operation.

Alternatively, the shift amount calculating unit 12 may define the ratio R calculated in accordance with equation (3), as the degree of reliability.

The shift amount calculating unit 12 outputs the local shift amount of each shift amount calculation area to the representative value calculating unit 15 and outputs the degree of reliability of each shift amount calculation area to the reliability degree correcting unit 14.

The inclusion level calculating unit 13 calculates, for each shift amount calculation area, an inclusion level of components which are included in an image of a subject and are each finer than the phase difference pixel distance. Since the inclusion level calculating unit 13 performs the same process for each shift amount calculation area, an inclusion level calculation process for one shift amount calculation area will be described below.

As described above, phase difference pixels used for calculation of a local shift amount are discretely arranged in a shift amount calculation area in some cases. In such a case, an edge of an image of a subject may not be accurately evaluated in a phase difference image due to a degree of sharpness of the edge of the image of the subject.

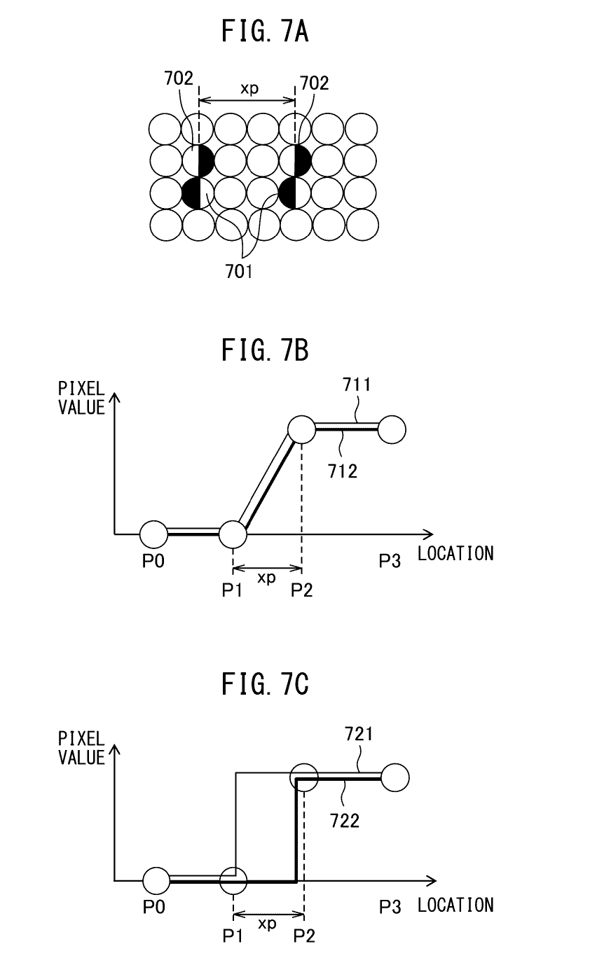

FIG. 7A is a diagram illustrating an example of arrangement of phase difference pixels. In this example, a distance between two adjacent left pixels 701 aligned in the horizontal direction, i.e., a phase difference pixel distance xp, is three pixels. Similarly, the phase difference pixel distance xp with regard to two adjacent right pixels 702 aligned in the horizontal direction is also three pixels.

FIG. 7B is a diagram illustrating an example of a relationship between a phase difference pixel distance and edges in the images of a subject in a left-hand image and a right-hand image. In FIG. 7B, the horizontal axis represents locations in the horizontal direction, and the vertical axis represents pixel values. A profile 711 represents a relationship between a pixel value and a horizontal-direction location near an edge of the image of the subject on the image sensor corresponding to the left-hand image. A profile 712 represents a relationship between a pixel value and a horizontal-direction location near an edge of the image of the subject on the image sensor corresponding to the right-hand image. Each of p0 to p3 represents a horizontal-direction location of each of a left pixel and a right pixel. In this example, the width of the edge is approximately equal to the phase difference pixel distance as illustrated in the profile 711 and the profile 712. This indicates that the sharpness of the edge of the image of the subject in each of the left-hand image and the right-hand image is substantially the same as the sharpness of the edge of the actual image of the subject. Hence, in this example, it is possible to evaluate a shift amount between the left-hand image and the right-hand image with relative accuracy.

FIG. 7C is a diagram illustrating another example of a relationship between a phase difference pixel distance and edges of the images of the subject in a left-hand image and a right-hand image. In FIG. 7C, the horizontal axis represents locations in the horizontal direction, and the vertical axis represents pixel values. A profile 721 represents a relationship between a pixel value and a horizontal-direction location near an edge of the image of the subject on the image sensor corresponding to the left-hand image. A profile 722 represents a relationship between a pixel value and a horizontal-direction location near an edge of the image of the subject on the image sensor corresponding to the right-hand image. Each of p0 to p3 represents a horizontal-direction location of each of a left pixel and a right pixel. In this example, the width of the edge is narrower than the phase difference pixel distance as illustrated in the profile 721 and the profile 722. For this reason, even when a location of the edge of the image of the subject in the left-hand image and a location of the edge of the image of the subject in the right-hand image are displaced from each other by a range narrower than the phase difference pixel distance, the edge location in the left-hand image and the edge location in the right-hand image coincide with each other. Accordingly, a degree of reliability of the local shift amount becomes lower than that in the case illustrated in FIG. 7B. Hence, when an edge is sharp so that the width of the edge is narrower than the phase difference pixel distance, the degree of reliability is inaccurate. In particular, the width of the edge is likely to be narrower than the phase difference pixel distance as the phase difference pixel distance increases or a blur amount decreases.

Further, an influence of aliasing increases as a ratio of frequency components each having a higher frequency than the Nyquist frequency of the phase difference image to the frequency components of the image of the subject on the image sensor 21 increases. In this case, the image of the subject in the phase difference image is different from the actual image of the subject. Consequently, the degree of reliability becomes inaccurate. The Nyquist frequency of the phase difference image is the inverse of two times the phase difference pixel distance.

As described above, an inclusion level of components which are included in an image of the subject and are each finer than the phase difference pixel distance affects a degree of reliability of the local shift amount, and the degree of reliability may be inaccurate depending on the inclusion level. The inclusion level calculating unit 13 therefore obtains, for each shift amount calculation area, components of each frequency in the image of the subject in the shift amount calculation area, with reference to the values of pixels for generating display images different from phase difference pixels in the shift amount calculation area, and calculates an inclusion level on the basis of the components of each frequency.

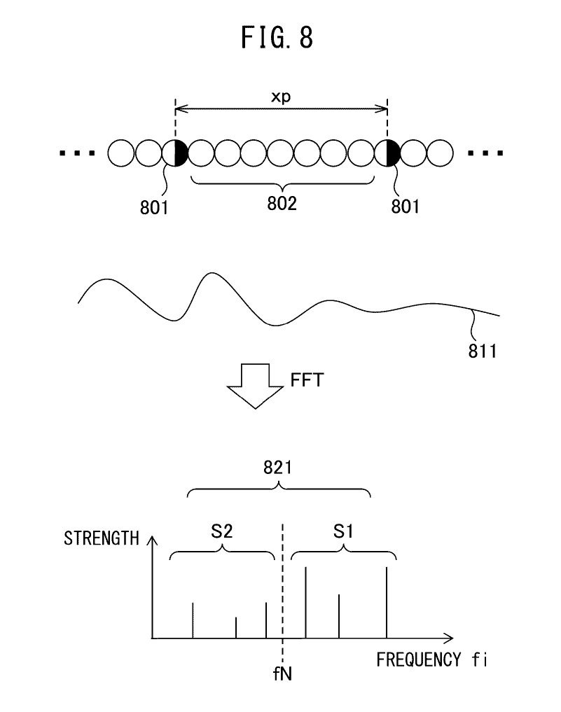

FIG. 8 is an explanatory diagram illustrating inclusion level calculation according to the present embodiment. The inclusion level calculating unit 13 performs Fast Fourier Transform (FFT) on a pixel row including two phase difference pixels 801 adjacent to each other in the direction for which a local shift amount is calculated, by use of pixel values of display image generation pixels 802 located between the two phase difference pixels 801. When FFT is performed, the inclusion level calculating unit 13 may use, for each of the phase difference pixels 801, a value calculated through bilinear interpolation or bicubic interpolation using pixel values of display pixels around the phase difference pixel 801. When there are a plurality of pixel rows including phase difference pixels in a shift amount calculation area, the inclusion level calculating unit 13 may perform FFT on each of the plurality of pixel rows and then average the obtained frequency components for each frequency. Further, the inclusion level calculating unit 13 may perform FFT on one of a pixel row including left pixels of the phase difference pixels and a pixel row including right pixels of the phase difference pixels, or may perform FFT on both of the pixel rows. When performing FFT on both rows, the inclusion level calculating unit 13 may average the frequency components obtained for the pixel row including left pixels and the frequency components obtained for the pixel row including right pixels, for each frequency. As a result, frequency characteristics 821 representing components in the direction for which a location shift amount is calculated, in a subject image 811 for each frequency, is obtained. Since the frequency characteristics 821 are calculated by use of display pixels having a narrower distance between adjacent pixels than the phase difference pixel distance, the frequency characteristics 821 include components S1 each having a higher frequency than a Nyquist frequency fN of the phase difference image as well as components S2 each having a frequency lower than the Nyquist frequency fN of the phase difference image.

The inclusion level calculating unit 13 therefore calculates, as an inclusion level, a ratio of the sum of components each having a frequency equal to or higher than the Nyquist frequency of the phase difference image to the total of components of all the frequencies of the subject in the phase difference image. For example, the inclusion level calculating unit 13 calculates an inclusion level E in accordance with the equations below.

$$E = \frac{S 1}{S 1 + S 2} S 1 = {{\sum }_{i = fN}}^{fH} {W}_{i} S 2 = {{\sum }_{i = fL}}^{fN - 1} {W}_{i} fN = \frac{fs}{2} = \frac{1}{2 xp} \qquad ( 4 )$$

where fL represents the lower limit of frequency, and fH represents the upper limit of frequency. Further, fN represents the Nyquist frequency of a phase difference image. xp represents a phase difference pixel distance, and fs represents a sampling frequency of the phase difference image. wᵢ represents a frequency component having a frequency i in an image of a subject, and may be the square, i.e., the power, of the frequency coefficient of the frequency i obtained through FFT, for example. Alternatively, wᵢ may be the absolute value of the frequency coefficient of the frequency i obtained through FFT.

The inclusion level calculating unit 13 outputs the inclusion level of each shift amount calculation area to the reliability degree correcting unit 14.

The reliability degree correcting unit 14 corrects, for each shift amount calculation area, a degree of reliability of a local shift amount of the shift amount calculation area on the basis of an inclusion level of the shift amount calculation area. Since the reliability degree correcting unit 14 performs the same process for each shift amount calculation area, a process for one shift amount calculation area will be described below.

In the present embodiment, the reliability degree correcting unit 14 corrects a value of the degree of reliability so that accuracy of a local shift amount represented by the degree of reliability decreases as the inclusion level increases. For example, when estimated variance, an expected value of an absolute error value of the local shift amount, or a ratio of the minimum SAD value to contrast is used as the degree of reliability, the value of the degree of reliability decreases as the accuracy of the local shift amount increases. In this case, the reliability degree correcting unit 14 corrects the degree of reliability so that a value of the degree of reliability increases as a level of inclusion increases. In this case, the reliability degree correcting unit 14 corrects the degree of reliability in accordance with the equation given below, for example.

$$\frac{1}{{V}^{′}} = ( 1 - {E}^{2} ) \frac{1}{V} \qquad ( 5 )$$

where V represents a degree of reliability before correction, and V′ represents the degree of reliability after correction.

When a degree of reliability is represented as a probability that a difference between a local shift amount and the correct shift amount is equal to or lower than a predetermined value, a value of the degree of reliability increases as accuracy of the local shift amount increases. In this case, the reliability degree correcting unit 14 corrects the degree of reliability so that a value of the degree of reliability decreases as a level of inclusion increases. In this case, the reliability degree correcting unit 14 corrects the degree of reliability in accordance with the equation given below, for example.

V′=(1−E²)V (6)

As described above, a value of the degree of reliability is corrected so that the accuracy of a local shift amount represented by the degree of reliability decreases as a level of inclusion increases. Hence, the reliability degree correcting unit 14 can appropriately reflect, in the degree of reliability, a possibility that accuracy in measurement of a local shift amount decreases due to a relationship between fineness of the subject and the phase difference pixel distance.

The reliability degree correcting unit 14 does not need to correct the degree of reliability when the level of inclusion is lower than a predetermined threshold (e.g., 0.1).

The reliability degree correcting unit 14 outputs the corrected degree of reliability of each shift amount calculation area to the representative value calculating unit 15.

The representative value calculating unit 15 calculates a representative shift amount representing a focus position for a subject appearing in a measurement area on the basis of the local shift amount and the corrected degree of reliability of each shift amount calculation area in the measurement area. In the present embodiment, the representative value calculating unit 15 calculates a representative shift amount so that a local shift amount of a shift amount calculation area having a higher corrected degree of reliability makes a larger contribution to the representative shift amount.

The representative value calculating unit 15 calculates a representative shift amount S of a measurement area by obtaining the weighted mean of local shift amounts of the respective shift amount calculation areas using the degrees of reliability, in accordance with the equation given below, for example.

$$S = \frac{{{\sum }^{N}}_{i = 1} {S}_{i} / {V}_{i}}{{{\sum }^{N}}_{i = 1} 1 / {V}_{i}} \qquad ( 7 )$$

where Sᵢ represents a local shift amount of the i-th shift amount calculation area, Vᵢ represents a degree of reliability of the i-th shift amount calculation area. N represents the number of shift amount calculation areas included in the measurement area. Equation (7) is applied when a value of the degree of reliability Vᵢ decreases as accuracy of the local shift amount Sᵢ increases, for example, when estimated variance is calculated as the degree of reliability. A shift amount calculation area having higher accuracy in the local shift amount Sᵢ, therefore, makes a larger contribution to the representative shift amount, as is apparent from equation (7). The representative value calculating unit 15 may define, as the representative shift amount S, the mean or the median of local shift amounts of the shift amount calculation areas each having a degree of reliability equal to or lower than a predetermined threshold, or a predetermined number of local shift amounts from the one having the lowest degree of reliability, instead of using equation (7).

When the value of the degree of reliability Vᵢ increases as accuracy of the local shift amount Sᵢ increases, for example, when a probability that the error of the local shift amount is equal to or lower than a predetermined value is calculated as the degree of reliability, the representative value calculating unit 15 may calculate the representative shift amount S in accordance with the equation given below, for example.

$$S = \frac{{{\sum }^{N}}_{i = 1} ( {S}_{i} \cdot {V}_{i} )}{{{\sum }^{N}}_{i = 1} {V}_{i}} \qquad ( 8 )$$

In this case, the representative calculating unit 15 may define, as the representative shift amount S, the mean or the median of local shift amounts of the shift amount calculation areas each having a degree of reliability equal to or higher than a predetermined threshold, or one of a predetermined number of local shift amounts having the highest degree of reliability, in place of equation (8).

Further, when the focusing unit 16 uses a contrast detection method at the same time, as will be described later, the representative value calculating unit 15 may calculate estimated variance of the representative shift amount (hereinafter referred to as representative variance) V. For example, when a value of degree of reliability, as estimated variance, decreases as accuracy of the local shift amount increases, the representative value calculating unit 15 calculates the representative variance V in accordance with the equation given below.

$$V = \frac{{{\sum }^{N}}_{i = 1} {( 1 / {V}_{i} )}^{2} {V}_{i}}{{{\sum }^{N}}_{i = 1} {( 1 / {V}_{i} )}^{2}} = \frac{{{\sum }^{N}}_{i = 1} 1 / {V}_{i}}{{{\sum }^{N}}_{i = 1} {( 1 / {V}_{i} )}^{2}} \qquad ( 9 )$$

The control unit 6 can cause the imaging unit 2 to focus on a subject appearing in the measurement area by moving the imaging optical system 22 along the optical axis by an amount of movement equivalent to the representative shift amount, and therefore, the representative shift amount represents the focus position. The representative value calculating unit 15 outputs the representative shift amount to the focusing unit 16. Note that when the focusing unit 16 uses a contrast detection method at the same time, as will be described later, the representative value calculating unit 15 also outputs the representative variance to the focusing unit 16.

The focusing unit 16 refers to a focus table to obtain an amount of rotation of the stepping motor which is equivalent to an amount of movement of the imaging unit 2 which corresponds to the representative shift amount. The focusing unit 16 then outputs, to the actuator 23, a control signal for causing the stepping motor of the actuator 23 of the imaging unit 2 to rotate by an amount obtained by subtracting an amount of rotation which is equivalent to a difference between the current position and the reference position of the imaging unit 2, from the obtained amount of rotation. The actuator 23 causes the stepping motor to rotate by the amount of rotation in accordance with the control signal, to move the imaging optical system 22 along the optical axis so that the representative shift amount becomes 0. Thereby, the imaging unit 2 can focus on the subject appearing in the measurement area.

According to the modified example, the focusing unit 16 may use a contrast detection method with the phase difference detection method to cause the imaging unit 2 to focus on a subject appearing in a measurement area. In this case, the focusing unit 16 first causes the stepping motor of the actuator 23 to rotate by an amount of rotation in accordance with a representative shift amount, to move the imaging optical system 22 along the optical axis so that the representative shift amount becomes 0, as described above. Then, the focusing unit 16 sets a range of the position of the imaging optical system 22, within which the contrast of the subject is checked, on the basis of representative variance received from the representative value calculating unit 15. For example, the focusing unit 16 sets a range equivalent to ±2 times the standard deviation corresponding to the representative variance, as the range of the position of the imaging optical system 22, within which the contrast of the subject is checked. The focusing unit 16 then finds a position of the imaging optical system 22 at which the contrast in an area equivalent to a measurement area on an image obtained by the imaging unit 2 is maximized while causing the imaging optical system 22 to move within the range. The focusing unit 16 sets the position of the imaging optical system 22 at which the contrast is maximized as the position at which the imaging optical system 22 focuses on the subject appearing in the measurement area. Note that when there is not a position at which the contrast is maximized within the set range of the position of the imaging optical system 22, the focusing unit 16 may find a position of the imaging optical system 22 at which the contrast is maximized even outside the range.

In this way, the focusing unit 16 is capable of appropriately setting a range of the position of the imaging optical system 22 within which the contrast is checked by using the contrast detection method even when the contrast detection method is used with the phase difference detection method at the same time. Accordingly, the focusing unit 16 can reduce the time required for the imaging unit 2 to focus on a subject in the measurement area.

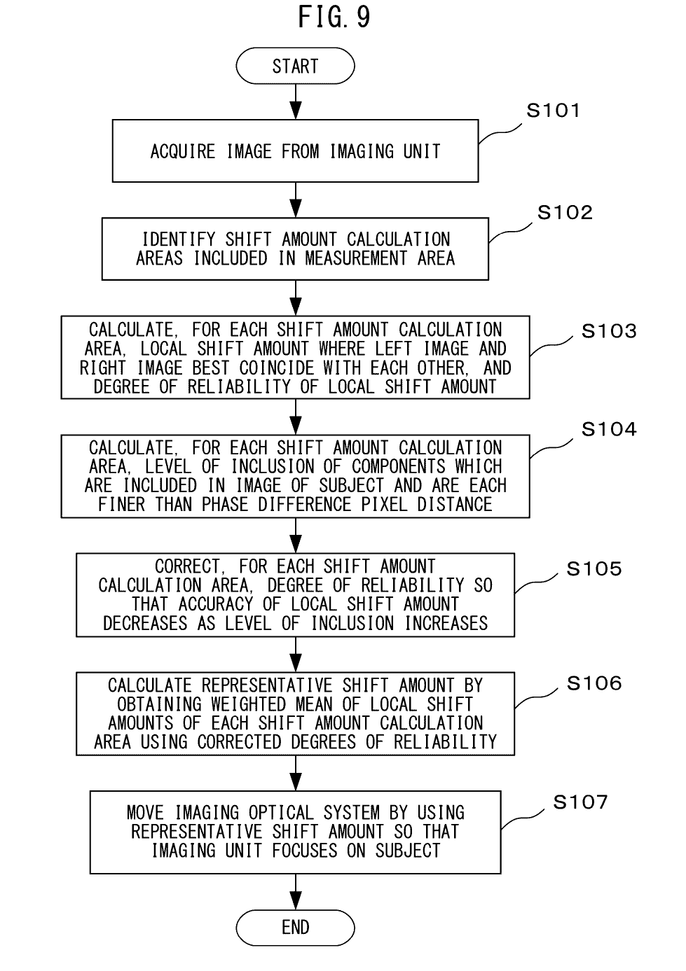

FIG. 9 is an operation flowchart of a focus position detection process executed by the control unit 6. The control unit 6 acquires a captured image of a subject from the imaging unit 2 (step S101). The control unit 6 then stores the image in the memory unit 5.

The shift amount calculation area identifying unit 11 identifies shift amount calculation areas included in a specified measurement area (step S102). The shift amount calculation area identifying unit 11 then provides the identified shift amount calculation areas for the shift amount calculating unit 12 and the inclusion level calculating unit 13.

The shift amount calculating unit 12 calculates, for each shift amount calculation area, a local shift amount at which a left-hand image and a right-hand image are most coincident with each other and a degree of reliability of the local shift amount on the basis of the image stored in the memory unit 5 (step S103). The shift amount calculating unit 12 then outputs the local shift amount of the shift amount calculation area to the representative value calculating unit 15 and the degree of reliability to the reliability degree correcting unit 14.

The inclusion level calculating unit 13 calculates, for each shift amount calculation area, a level of inclusion of components, in the shift amount calculation area, which are included in the image of the subject and are each finer than the phase difference pixel distance (Step S104). The inclusion level calculating unit 13 then outputs the level of inclusion of each shift amount calculation area to the reliability degree correcting unit 14.

The reliability degree correcting unit 14 corrects, for each shift amount calculation area, the degree of reliability so that accuracy of the local shift amount represented by the degree of reliability decreases as the level of inclusion of the shift amount calculation area increases (Step S105). The reliability degree correcting unit 14 then outputs the corrected degree of reliability of each shift amount calculation area to the representative value calculating unit 15.

The representative value calculating unit 15 calculates a representative shift amount of the entire measurement area by obtaining the weighted mean of local shift amounts of each shift amount calculation area using the corrected degrees of reliability (Step S106). The representative value calculating unit 15 outputs the representative shift amount to the focusing unit 16.

On the basis of the representative shift amount, the focusing unit 16 causes the imaging optical system 22 of the imaging unit 2 to move along the optical axis so that the imaging unit 2 focuses on the subject appearing in the measurement area (step S107). The control unit 6 then terminates the focus position detection process.

As described above, the focus position detection apparatus corrects a degree of reliability for each shift amount calculation area included in a measurement area so that the degree of reliability of a local shift amount decreases as a level of inclusion of components which are included in the image of the subject and are each finer than the phase difference pixel distance increases. The focus position detection apparatus then obtains a representative shift amount representing a focus position by obtaining the weighted mean of local shift amounts of each shift amount calculation area using the corrected degrees of reliability. Therefore, the focus position detection apparatus can reduce an error in focus position in each shift amount calculation area due to components which are included in the image of the subject and are each finer than the phase difference pixel distance.

Next, a focus position detection apparatus according to a second embodiment will be described. The focus position detection apparatus according to the second embodiment calculates a level of inclusion of components which are included in an image of a subject and are each finer than a phase difference pixel distance, by comparing sharpness of an edge in a phase difference image with sharpness of an edge in a display image.

The focus position detection apparatus according to the second embodiment is different from the focus position detection apparatus according to the first embodiment in terms of a process performed by the inclusion level calculating unit 13. Therefore, the inclusion level calculating unit 13 and the related parts will be described below. For the other components of the focus position detection apparatus according to the second embodiment, refer to the description of the corresponding components of the focus position detection apparatus according to the first embodiment.

As described regarding FIGS. 7A to 7C, a degree of reliability of a shift amount calculation area may be inaccurate due to a relationship between a width of an edge of an image of a subject and a phase difference pixel distance in the shift amount calculation area. To address this, in the present embodiment, the inclusion level calculating unit 13 calculates a level of inclusion for each shift amount calculation area on the basis of an edge strength of an image of the subject in a phase difference image and an edge strength of an image of the subject in a corresponding area of a display image. Since the inclusion level calculating unit 13 performs the same process for each shift amount calculation area in the second embodiment as the above, an inclusion level calculation process for one shift amount calculation area will be described below.

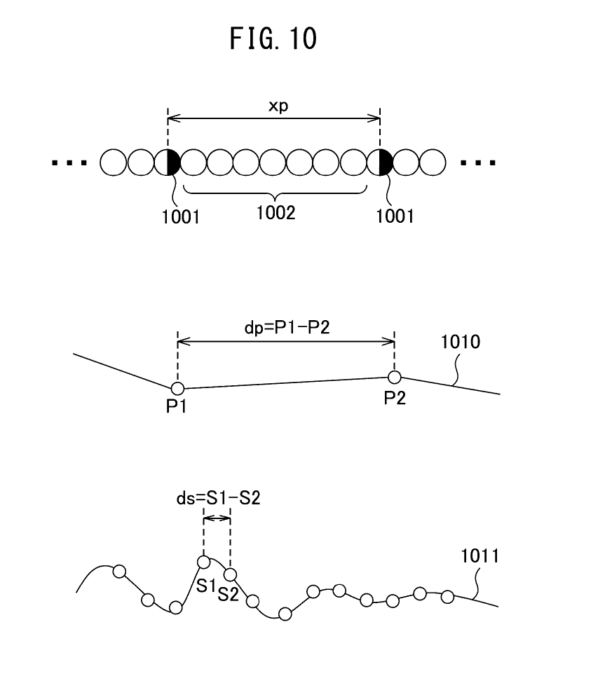

FIG. 10 is an explanatory diagram of inclusion level calculation according to the second embodiment. In this example, a phase difference pixel distance xp between phase difference pixels 1001 corresponds to eight display image generation pixels 1002. The inclusion level calculating unit 13 calculates, for each phase difference pixel, a difference value dp (=p1−p2) between pixel values p1 and p2 of the two phase difference pixels 1001 adjacent to each other in the direction for which a local shift amount is calculated, for a shift amount calculation area in a phase difference image 1010. Each phase difference pixel for which a difference value is calculated may be one of a left pixel or a right pixel, or may be both. The inclusion level calculating unit 13 further calculates, for each display image generation pixels 1002 between the phase difference pixels, a difference value ds (=s1−s2) between pixel values s1 and s2 of the pixels adjacent to each other in the direction for which a local shift amount is calculated, in an area corresponding to the shift amount calculation area in a display image 1011. The inclusion level calculating unit 13 calculates an inclusion level E in accordance with the equations given below, for example.

$$E = 1 - \frac{Sdp}{Sds} Sdp = \sqrt{{{\sum }^{Np - 1}}_{i = 0} ( xp \cdot {( {dp}_{i} / xp )}^{2} )} \\ Sds = \sqrt{{{\sum }^{Np - 1}}_{i = 0} {( {dp}_{j} )}^{2}} \qquad ( 10 )$$

where Np represents the number of phase difference pixels included in a shift amount calculation area, and Ns represents the number of display image generation pixels for which a difference value is calculated, i.e., pixels located between two adjacent phase difference pixels. dpᵢ represents a difference value between adjacent phase difference pixels for the i-th phase difference pixel, and dsⱼ represents a difference value between adjacent pixels for the j-th display image generation pixel. As is clear from equations (10), the level of inclusion increases as the sum of squares of difference values of the display image generation pixels increases in comparison with the sum of squares of difference values of the phase difference pixels. In other words, the level of inclusion increases as the edge strength of the corresponding area in the display image increases in comparison with the edge strength of the phase difference image.

In the second embodiment, as the above, the reliability degree correcting unit 14 may correct, for each shift amount calculation area, the degree of reliability in accordance with equation (5) or equation (6) by use of the level of inclusion calculated for the shift amount calculation area.

According to the second embodiment, the inclusion level calculating unit 13 does not need to perform any frequency transform process and can hence reduce computation amount required for inclusion level calculation.

According to a modified example of the second embodiment, the inclusion level calculating unit 13 may calculate a level of inclusion in accordance with a ratio between contrast and sharpness of an area corresponding to a shift amount calculation area in a display image. In this case, the inclusion level calculating unit 13 calculates the level of inclusion in accordance with the equations given below, for example.

$$E = \frac{SH}{C} \\ SH = {{\sum }^{Ns - 1}}_{j = 0} {ds}_{j}^{2} / {{\sum }^{Ns - 1}}_{j = 0} \vert {ds}_{j} \vert \qquad ( 11 )$$

where SH represents sharpness. C represents contrast and is calculated, for example, as a difference between the maximum pixel value and the minimum pixel value in an area corresponding to the shift amount calculation area in the display image. It is assumed that the fineness of a structure of the image of the subject increases in comparison with a phase difference pixel distance as the sharpness SH increases in comparison with the contrast C. Therefore, according to equations (11), a value of the level of inclusion increases as the sharpness SH increases in comparison with the contrast C.

According to still another modified example, the focus position detection apparatus may be applied in an imaging apparatus which obtains two images which have a parallax with respect to a subject, such as a stereo camera, for measuring a distance to the subject as well as detecting a focus position by a phase difference detection method. In this case, a distance table which indicates a relationship between a representative shift amount and a distance to a subject from the imaging apparatus is stored in a memory unit of the imaging apparatus prior to operation, for example. A control unit of the imaging apparatus can execute each function of the control unit according to any of the embodiments described above, on two parallax-images generated by the imaging apparatus, to calculate a representative shift amount for a subject appearing in a measurement area set in each image sensor which generates images. The control unit can then obtain a distance from the imaging apparatus to the subject appearing in the measurement area, which corresponds to the representative shift amount with reference to the distance table.

According to still another modified example, an image sensor for generating phase difference images and an image sensor for generating display images may be provided separately.

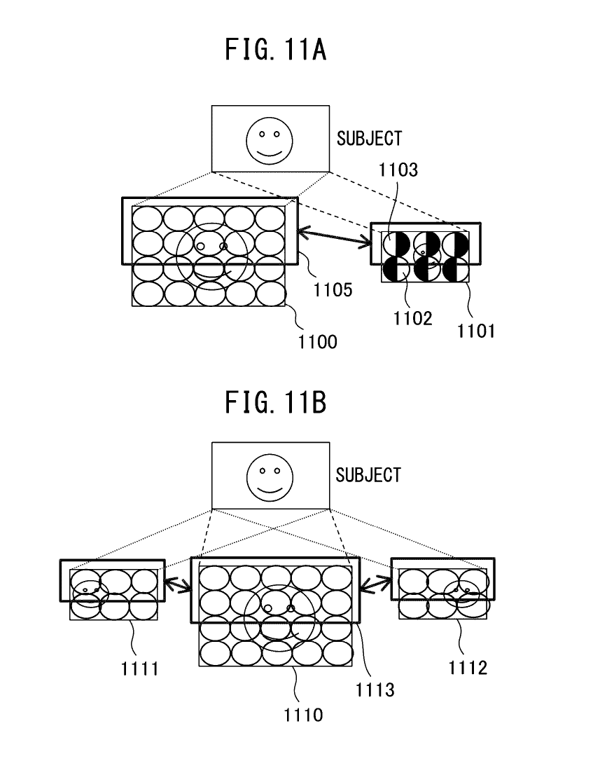

FIGS. 11A and 11B are diagrams each illustrating a relationship between an image sensor for generating phase difference images and an image sensor for generating display images according to this modified example. In the example illustrated in FIG. 11A, a single phase difference image generation image sensor 1101 is provided separately from a display image generation image sensor 1100. A beam splitter (not depicted) is provided, for example, between an imaging optical system (not depicted) and each image sensor so that an imaging region of the phase difference image generation image sensor 1101 is included in an imaging region of the display image generation image sensor 1101. A light beam coming from the optical imaging system is split by the beam splitter, and an image is formed on each of the image sensor 1100 and the image sensor 1101.

In this example, the image sensor 1101 includes a pixel row in which a plurality of left pixels 1102 for generating left-hand images are arranged in the horizontal direction and a pixel row in which a plurality of right pixels 1103 for generating right-hand images are arranged in the horizontal direction. The image sensor 1101 therefore generates both a left-hand image and a right-hand image. A resolution of the image sensor 1101 is lower than that of the image sensor 1100. The inclusion level calculating unit 13 may therefore calculate a level of inclusion by use of pixel values of the pixels included in an area 1105 of the image sensor 1100, which corresponds to the imaging region of the image sensor 1101, in accordance with any of the embodiments and the modified examples above.

In the example illustrated in FIG. 11B, two phase difference image generation image sensors 1111 and 1112 are provided separately from a display image generation image sensor 1110. The image sensor 1111 generates left-hand images, and the image sensor 1112 generates right-hand images. In this example, for example, a stereo optical system (not depicted) including two imaging optical systems provided with a distance from each other in the direction in which the image sensors 1111 and 1112 are arranged, is provided, to form an image of a subject on the phase difference image generation image sensors 1111 and 1112. A left-hand image generated by the image sensor 1111 and a right-hand image generated by the image sensor 1112 therefore have a parallax which corresponds to distances to the subject. In this example, an imaging optical system (not depicted) which focuses an image of the subject on the image sensor 1110 is further provided. The respective imaging optical systems can integrally move in the optical axis direction of the imaging optical systems. Further, the imaging regions of the phase difference image generation image sensors 1111 and 1112 are included in the imaging region of the image sensor 1110.

In this example as the above, the resolution of each of the image sensors 1111 and 1112 is lower than that of the image sensor 1110. The inclusion level calculating unit 13 may therefore calculate a level of inclusion by use of pixel values of the pixels included in an area 1113 of the image sensor 1110 corresponding to the imaging regions of the image sensors 1111 and 1112, in accordance with any of the embodiments and the modified examples above.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An imaging apparatus comprising:
a camera which includes an image sensor in which phase difference detectors detecting a phase difference to be used for calculating a focus position by using an image surface phase difference detection method, are disposed at a plurality of locations in a light receiving surface, and captures an image of a subject by using a light incident on the light receiving surface of the image sensor via an optical system with a movable focal point position; and
a processor configured to calculate, when a frequency value calculated by using a pixel value located between a first phase difference detector and a second phase difference detector among a plurality of the phase difference detectors is larger than or equal to a predetermined value, the focus position based on phase differences detected by a plurality of the phase difference detectors with reduced contribution of a phase difference by the first phase difference detector and the second phase difference detector.

2. A focus position detection apparatus comprising:
a processor configured to:
identify a plurality of shift amount calculation areas included in a measurement area set on an image sensor in a camera including the image sensor generating an image and an optical system, each of the plurality of shift amount calculation areas including a plurality of first pixels generating a first sub-image representing a subject appearing in the shift amount calculation area and a plurality of second pixels generating a second sub-image representing the subject appearing in the shift amount calculation area, wherein an amount of shift between the subject on the first sub-image and the subject on the second sub-image changes in accordance with a distance between a focus position by the optical system for the subject and the image sensor;
calculate, for each of the plurality of shift amount calculation areas, a local shift amount of the second sub-image with respect to the first sub-image when the subject on the first sub-image and the subject on the second sub-image are most coincident with each other, and a degree of reliability representing accuracy of the local shift amount;
calculate, for each of the plurality of shift amount calculation areas, a level of inclusion of a component included in an image of the subject in the shift amount calculation area and being finer than a distance between the two adjacent first pixels or a distance between the two adjacent second pixels;
correct, for each of the plurality of shift amount calculation areas, the degree of reliability of the shift amount calculation area, based on the level of inclusion of the shift amount calculation area; and
calculate a representative value representing a distance between a focus position by the optical system and the image sensor, so that contribution of the local shift amount of each of the plurality of the shift amount calculation areas to the representative value increases as the corrected degree of reliability of the shift amount calculation area increases.

3. The focus position detection apparatus according to claim 2, wherein correction of the degree of reliability corrects, for each of the plurality of shift amount calculation areas, the degree of reliability so that accuracy of the local shift amount represented by the degree of reliability of the shift amount calculation area decreases as the level of inclusion of the shift amount calculation area increases.

4. The focus position detection apparatus according to claim 2, wherein calculation of the level of inclusion calculates, for each of the plurality of shift amount calculation areas, a component in an image of the subject in a corresponding area on the image sensor, for each frequency, and increases the level of inclusion as a ratio of a sum of components of frequencies higher than or equal to a Nyquist frequency, corresponding to a distance between the two adjacent first pixels or a distance between the two adjacent second pixels, to a sum of each frequency component in the image of the subject increases.

5. The focus position detection apparatus according to claim 2, wherein calculation of the level of inclusion increases, for each of the plurality of shift amount calculation areas, the level of inclusion as a ratio of edge strength of an image of the subject in a corresponding area on the image sensor to edge strength of the first sub-image or the second sub-image increases.

6. The focus position detection apparatus according to claim 2, wherein calculation of the representative value calculates the representative value by obtaining a weighted mean of the local shift amount of each of the plurality of respective shift amount calculation areas using the corrected degree of reliability.

7. A focus position detection method comprising:
identifying a plurality of shift amount calculation areas included in a measurement area set on an image sensor in a camera including the image sensor generating an image and an optical system, each of the plurality of shift amount calculation areas including a plurality of first pixels generating a first sub-image representing a subject appearing in the shift amount calculation area and a plurality of second pixels generating a second sub-image representing the subject appearing in the shift amount calculation area, wherein an amount of shift between the subject on the first sub-image and the subject on the second sub-image changes in accordance with a distance between a focus position by the optical system for the subject and the image sensor;
calculating, for each of the plurality of shift amount calculation areas, a local shift amount of the second sub-image with respect to the first sub-image when the subject on the first sub-image and the subject on the second sub-image are most coincident with each other, and a degree of reliability representing accuracy of the local shift amount;
calculating, for each of the plurality of shift amount calculation areas, a level of inclusion of a component included in an image of the subject in the shift amount calculation area and being finer than a distance between the two adjacent first pixels or a distance between the two adjacent second pixels;
correcting, for each of the plurality of shift amount calculation areas, the degree of reliability of the shift amount calculation area, based on the level of inclusion of the shift amount calculation area; and
calculating a representative value representing a distance between a focus position by the optical system and the image sensor so that contribution of the local shift amount of each of the plurality of shift amount calculation areas to the representative value increases as the corrected degree of reliability of the shift amount calculation area increases.

8. The focus position detection method according to claim 7, wherein correction of the degree of reliability corrects, for each of the plurality of shift amount calculation areas, the degree of reliability so that accuracy of the local shift amount represented by the degree of reliability of the shift amount calculation area decreases as the level of inclusion of the shift amount calculation area increases.

9. The focus position detection method according to claim 7, wherein calculation of the level of inclusion calculates, for each of the plurality of shift amount calculation areas, a component in an image of the subject in a corresponding area on the image sensor, for each frequency, and increases the level of inclusion as a ratio of a sum of components of frequencies higher than or equal to a Nyquist frequency, corresponding to a distance between the two adjacent first pixels or a distance between the two adjacent second pixels, to a sum of each frequency component in the image of the subject increases.

10. The focus position detection method according to claim 7, wherein calculation of the level of inclusion increases, for each of the plurality of shift amount calculation areas, the level of inclusion as a ratio of edge strength of an image of the subject in a corresponding area on the image sensor to edge strength of the first sub-image or the second sub-image increases.

11. The focus position detection method according to claim 7, wherein calculation of the representative value calculates the representative value by obtaining a weighted mean of the local shift amount of each of the plurality of respective shift amount calculation areas using the corrected degree of reliability.

12. A non-transitory computer-readable recording medium having recorded thereon a computer program for focus position detection that causes a computer to execute a process comprising:
identifying a plurality of shift amount calculation areas included in a measurement area set on an image sensor in a camera including the image sensor generating an image and an optical system, each of the plurality of shift amount calculation areas including a plurality of first pixels generating a first sub-image representing a subject appearing in the shift amount calculation area and a plurality of second pixels generating a second sub-image representing the subject appearing in the shift amount calculation area, wherein an amount of shift between the subject on the first sub-image and the subject on the second sub-image changes in accordance with a distance between a focus position by the optical system for the subject and the image sensor;
calculating, for each of the plurality of shift amount calculation areas, a local shift amount of the second sub-image with respect to the first sub-image when the subject on the first sub-image and the subject on the second sub-image are most coincident from each other, and a degree of reliability representing accuracy of the local shift amount;
calculating, for each of the plurality of shift amount calculation areas, a level of inclusion of a component included in an image of the subject in the shift amount calculation area and being finer than a distance between the two adjacent first pixels or a distance between the two adjacent second pixels;
correcting, for each of the plurality of shift amount calculation areas, the degree of reliability of the shift amount calculation area, based on the level of inclusion of the shift amount calculation area; and
calculating a representative value representing a distance between a focus position by the optical system and the image sensor so that contribution of the local shift amount of each of the plurality of shift amount calculation areas to the representative value increases as the corrected degree of reliability of the shift amount calculation area increases.

13. An imaging apparatus comprising:
a camera which includes an image sensor generating an image and including a plurality of shift amount calculation areas, and an optical system, each of the plurality of shift amount calculation areas including a plurality of first pixels generating a first sub-image representing a subject appearing in the shift amount calculation area and a plurality of second pixels generating a second sub-image representing the subject appearing in the shift amount calculation area, wherein an amount of shift between the subject on the first sub-image and the subject on the second sub-image changes in accordance with a distance between a focus position by the optical system for the subject and the image sensor; and
a controller which causes the camera to focus on the subject,
wherein the controller configured to:
identify, among the plurality of shift amount calculation areas, shift amount calculation areas included in a measurement area set on the image sensor;
calculate, for each of the plurality of shift amount calculation areas included in the measurement area, a local shift amount of the second sub-image with respect to the first sub-image when the subject on the first sub-image and the subject on the second sub-image are most coincident with each other, and a degree of reliability representing accuracy of the local shift amount;
calculate, for each of the plurality of shift amount calculation areas, a level of inclusion of a component included in an image of the subject in the shift amount calculation area and being finer than a distance between the two adjacent first pixels or a distance between the two adjacent second pixels;
correct, for each of the plurality of shift amount calculation areas, the degree of reliability of the shift amount calculation area, based on the level of inclusion of the shift amount calculation area;
calculate a representative value representing a distance between a focus position by the optical system and the image sensor so that contribution of the local shift amount of each of the plurality of shift amount calculation areas to the representative value increases as the corrected degree of reliability of the shift amount calculation area increases; and
cause the camera to focus on the subject in accordance with the representative value.
